(19) United States
(12) Patent Application Publication
(10) Pub. No.: US 2012/0030134 A1
(43) Pub. Date: Feb. 2, 2012

(54) System For Tracking USPS Mail, Predicting Delivery Times And Comparing USPS Costs Against Private Courier Services

(75) Inventors: Charles Campbell, Temecula, CA (US); Gerard F. Walz, Bonsall, CA (US)

(73) Assignee: WALZ GROUP

(21) Appl. No.: 13/194,028

(22) Filed: Jul. 29, 2011

Related U.S. Application Data
(60) Provisional application No. 61/369,555, filed on Jul. 30, 2010.

(51) Int. Cl. G06Q 30/00

(52) U.S. Cl. 705/333; 705/335

(57) ABSTRACT

A method of providing a sender of a package with: (i) a calculated delivery time if the package is sent through the USPS mail stream, and (ii) a calculated delivery cost savings by sending the package by USPS mail as compared to sending the package by private courier; calculating an expected delivery time if the package is sent by USPS mail based; providing the sender with the expected delivery time; determining a cost of sending the package by USPS mail; determining a cost of sending the package by private courier; calculating a cost savings by sending the package by USPS mail as compared to sending the package by private courier; and providing the sender with the calculated cost savings. Thus, a real-time analysis of various senders' true delivery experience empowers users to switch to a more economical model.

### RELATED APPLICATION

The present invention claims priority to U.S. Provisional Patent Application Ser. No. 61/369,555, filed Jul. 31, 2010, of the same title which is fully incorporated by reference herein for all purposes.

### TECHNICAL FIELD

The present invention relates to systems for tracking mail delivery times and costs.

### BACKGROUND OF THE INVENTION

The top two national courier service providers, FedEx & UPS, have a delivery infrastructure that specializes in the overnight and/or expedited delivery of letters/packages. In this model, all packages accumulate at various collection points, are transported to an airport collection facility, and are shipped via airfreight to central hub locations. At the hub locations, the packages are sorted and distributed to the appropriate delivery vehicles which then transport them to their final destination. That delivery vehicle may be a truck or even airfreight depending on the destination location. Regardless of the delivery point, all packages enter and exit a central hub, even if the destination address is within the same city as the originating address. In order to expedite delivery, these couriers charge a premium due to the associated costs of utilizing expensive transportation methods. Only high-volume users negotiate and realize deep volume-based discounts, with the majority of customers typically paying full price. While Fedex and UPS are used as primary cases in point, other courier service providers such as DHL and Airborne Express utilize similar shipping and delivery models.

Simply put, the majority of clients using these existing national couriers pay premium prices for an overnight guarantee, when they are really looking for non-expedited trackable and accountable delivery. The couriers try to address this problem by requiring clients to place secondary endorsements on the package that enable delayed delivery, i.e. second day, third day, ground, etc. thereby experiencing discounted pricing. The problem with these solutions is that they require coordinated second steps by the user (i.e. keeping separate inventory of stickers, placing endorsements, etc.) in order to trigger the discounts.

The customer billing from FedEx and UPS can also be problematic. Specifically, when a customer utilizes the online system to estimate the cost of the shipment, it only calculates the front end price, but does not include the backend billing which is calculated and billed after the service is rendered. Additional fees include address correction, fuel surcharges, residential surcharges, etc. Hence, the initial online calculated price is not usually a full representation of the actual total shipping cost, and there is not an easy, universal access or visibility to the true cost of all shipments over a certain period of time.

In summary, current national courier infrastructures (e.g.: FedEx and UPS) provide a premium, guaranteed package delivery system with a low visibility to true costs that are billed after delivery. The present invention provides a novel system to address these concerns as outlined below.

### SUMMARY OF THE INVENTION

### I.e.: Statement of the Solution to the Problem

Broadly stated, the present solution to the problems described above is to establish a new national courier service provider that utilizes a dynamically efficient delivery model through the optional preferred use of envelope and label that will control costs, provide dynamic feedback on delivery performance, and create a true transactional fixed-cost pricing model that also provides universal visibility to the “total cost of shipping” (TCS). In one preferred embodiment, the envelope may be a 9×12 envelope with a customized 4×6 shipping label. Alternatively, the labeling may be accomplished by laser printing on a 8½×11 sheet of paper that is folded in half and placed in a plastic window on the envelope. It is therefore to be understood that the present invention is not limited to any particular envelope or paper or label sizes. As such, it is to be understood that although the present invention is described in terms of a 9×12 envelope with a 4×6 shipping label, that design is merely exemplary. Rather, the present invention encompasses any dimension of letter, mailer, package or parcel. The key differentiator between the present invention and existing couriers' products is that where delivery time may be variable, deliverables such as tracking, online delivery of signatures, and interim notifications are preferably provided at a fixed cost per package. In accordance with the present system, enhanced visibility is provided to customers so they can see actual real-time delivery times and confirmations. In addition, customers are provided with costs that are immediately visible.

Note: In each of the examples detailed below, the first mail service may optionally be the USPS, and the second mail service may optionally be a private mail service courier. In its preferred embodiment, the present invention is used to promote USPS services by comparing them to the services of private couriers. It is to be understood, however, that the present invention is not so limited. For example, the first and second mail services may both be private mail courier companies. In that embodiment, the present invention can be used to compare the services of one courier to that of another.

In a first embodiment, the present invention provides a method of providing the sender of a mail piece with: (i) a calculated estimated delivery time, and (ii) a calculated estimated delivery cost savings by sending the piece via a first mail service (which may optionally comprise the United States Postal Service (USPS) working together with WALZ corporation) as compared to sending the piece by a second mail service (which may optionally comprise a private courier), comprising:

recording sender and recipient information for the package;

calculating an expected delivery time based upon both: (i) the sender and recipient address information for the package, and (ii) historical mail delivery performance records for the first mail service;

providing the sender with the expected delivery time;

determining the cost of sending the piece via the first mail service (preferably through the USPS working with WALZ corporation);

determining the cost of sending the package by the second mail service (preferably a private courier);

calculating estimated cost savings by sending the package via the first mail service as compared to sending the package by the second mail service; and

providing the sender with the calculated cost savings of sending the package via the first mail service as compared to sending the piece by the second mail service (eg: by a private courier).

In a second embodiment, the present invention provides a system for tracking a package through a first mail service (preferably the USPS) mail stream, comprising:

a package travelling through the first mail service mail stream between a sender and a recipient; and

a data record associated with the mail piece, the data record comprising:
a calculated expected delivery time if the package is sent through the first mail service mail stream based upon both: (i) sender and recipient address information for the package, and (ii) historical USPS mail delivery performance records, and
the calculated cost savings of sending the package via the first mail service (e.g.: USPS) as compared to sending the package the second mail service (e.g.: a private courier).

In a third embodiment, the present invention provides a trackable envelope for sending documents, comprising:

an envelope (or package); and

a unique machine-readable identifier on the envelope (or package), wherein the machine-readable identifier, when read by a USPS scanner:
(i) identifies the package as being from a particular USPS class of trackable mail,
(ii) provides a data record associated with the package, the data record comprising:
   (1) a calculated expected delivery time if the package is sent by the USPS based upon both:
      (a) sender and recipient address information for the package, and (b) historical USPS mail delivery performance records, and
   (2) the calculated cost savings of sending the package by USPS as compared to sending the package by private courier.

In a fourth embodiment, the present invention provides a computerized system for tracking envelopes or packages, comprising:

a sub-system for recording sender and recipient address information for the packages;

a sub-system for calculating an expected delivery time for individual packages if the individual packages are sent via a first mail service (which may include the USPS) based upon both: (i) the sender and recipient information for the mail piece, and (ii) historical mail delivery performance records;

a sub-system for providing senders with the expected delivery time for the individual mail pieces if the packages are sent by the first mail service;

a sub-system for determining the cost of sending the individual packages by the first mail service;

a sub-system for determining the cost of sending the individual packages by a second mail service (such as a private courier);

a sub-system for calculating the cost savings by sending the individual packages by the first mail service as compared to sending the mail piece by a second mail service such as a private courier; and

a sub-system for providing the sender with the calculated cost savings of sending the individual packages by the first mail service as compared to sending the individual packages by the second mail service.

Advantages of the present invention are many and described herein. Specific advantages of the present invention include (but are not limited to) the following:

The present system can be contracted with the USPS (i.e.: the largest letter delivery courier service in the country) which can provide coast to coast delivery in the continental US with a less than 3 day point-to-point delivery performance.

The present system provides a specialized envelope that is approved for universal acceptance and can support USPS Critical Mail™, USPS Priority Mail™, USPS Certified Mail™, USPS First Class Mail™, and all special services with a single label.

The present system can estimate future savings based on national delivery performance prior to first use.

The present system can analyze delivery performance and cost savings as compared to other national couriers using the cumulative, real-time experience data of the client.

The present system can provide a web-based user interface that supports the buying decision on a per-transaction basis, time period basis or an aggregation of certain users' basis.

The present system can be based on logic that analyzes and predicts the final disposition of the courier service to assist in initiating next steps in the process or communication chain. The presentation is through a web-based user interface that will dynamically illustrate delivery zone performance based on a single point of origination or destination or multiple combinations thereof. Additionally, the web-based interface and its associated logic also provides postal zone delivery and cost performance in real time, providing an actual real world tracking and management system.

It is to be understood that the present references to WALZ corporation herein are for illustrative purposes only, and that the present invention could be operated by any subsidiaries or successors to WALZ corporation. In addition, the present claims are not limited to WALZ corporation, but cover the present invention if operated by any business entity, however owned.

In various preferred aspects, WALZ corporation can operate the present invention as a distributed origination model or as a centralized origination facility.

### BRIEF DESCRIPTION OF THE DRAWINGS

FIG. 1 is a flowchart illustrating the preferred method.

FIG. 2 is an illustration of an example envelope used in accordance with the present invention.

FIG. 3 is an illustration of the system components of the present invention as embodied in a computerized system.

### DETAILED DESCRIPTION OF THE DRAWINGS

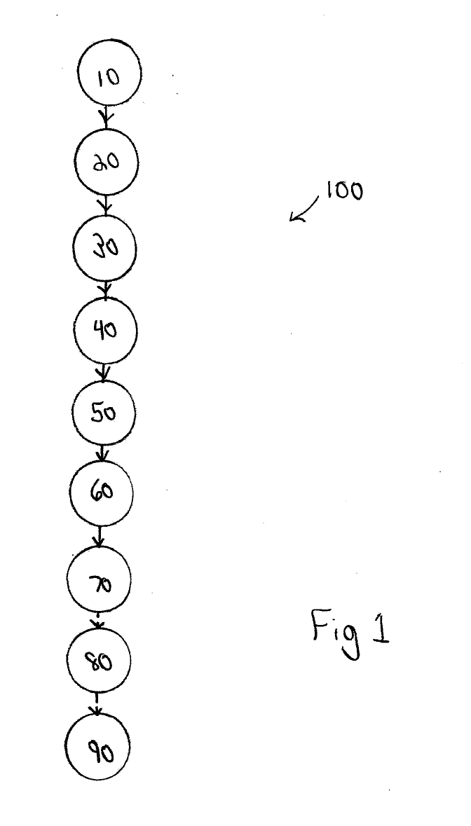

Referring first to FIG. 1, an example method 100 of sending mail is provided. As will be explained, method 100 provides the sender with: (i) a calculated delivery time if the mail piece is sent by a first mail service (which may include WALZ corporation's proprietary “DocuTrak™” system operated in conjunction with the USPS), and (ii) a calculated delivery cost savings by sending the mail piece by WALZ's DocuTrak™ as compared to sending the mail piece by private courier.

As used herein in the specification and claims herein, the word “package” is defined to include any form of mail piece including, packages, parcels, envelopes, mailers, flyers, etc. The present invention is not limited to any particular size or type of mail piece.

In preferred aspects, method 100 comprises the following steps:

Step 10: recording sender and recipient address information for the package;

Step 20: calculating an expected delivery time if the package is sent by the first mail service based upon both: (i) the sender and recipient address information for the package, and (ii) historical mail delivery performance records (such as USPS records);

Step 30: providing the sender with the expected delivery time if the package is sent by the first mail service;

Step 40: determining the cost of sending the package by the first mail service;

Step 50: determining the cost of sending the package by a second mail service such as a private courier;

Step 60: calculating the estimated cost savings achieved by sending the package by the first mail service as compared to sending the package by private courier; and

Step 70 providing the sender with the calculated cost savings of sending the package by the first mail service as compared to sending the package by the second mail service.

In method 100, the package is preferably sent utilizing the delivery infrastructure of the United States Postal Service (USPS). For example, the creator of the package may place the package in the USPS mail stream either by a USPS carrier pickup, dropping it off at a USPS Post Office or dropping in a USPS Drop Box. The package is first scanned in by the USPS (i.e.: step 10). At this step, both sender and recipient address information is recorded. Thus, the package will be tracked and information will be uploaded from USPS to WALZ's proprietary DocuTrak™ system. The important advantage of the present method is that the system determines how long it will take until the package is delivered (step 20) and then informs the sender both: (a) when the package will be delivered, and (b) how much money they saved by using the present system (as opposed to utilizing a courier such as FedEx or UPS).

Clients using the present invention will quickly realize that not every package sent via. FED EX or UPS Overnight actually requires overnight service. Often, the customer simply needs tracking and delivery signature. Most often customers will choose delayed delivery (of 2 to 3 days) when faced with the realization of overnight delivery costs. Based on this analysis, clients might be more inclined to utilize an alternative method at a fixed-cost rate, with the high probability that the package will arrive in an average of 2 days. For example, a sender may be satisfied using the present system if they were assured the package has a “95% chance of being delivered within 1 day, and a 99% chance of being delivered within two days.” Currently, many people simply use private couriers as they feel it is the only way to “guarantee” fast and trackable delivery, with accountability for who received it at the destination (delivery signature).

What the present invention does is provide senders with a reasonably accurate delivery time forecast, which would encourage them to use the present invention (as opposed to using much more expensive private couriers like FedEx and UPS). The present system provides reasonably accurate delivery time forecasts by analyzing the point of entry and point of delivery of the package. Preferably, the expected delivery time is displayed on a web-interface operated by WALZ corporation and viewed by the actual sender.

In optional preferred aspects, the present web interface can also be accessed by the recipients of the packages to track the mail that is heading to them from registered senders. When both the senders and recipients are registered users of the system, they can both optionally view letters and parcels passing back and forth between them.

In addition, the present system provides senders with a cost comparison between sending mail by the USPS and other private couriers. Thus, the sender is notified of the amount of money saved by utilizing the present system. As a result, a sender would receive a message such as:

“Your delivery cost equals $9.95. If you had used a private courier, it would have cost $27.95. You've saved $18.00! There is a 95% chance your letter will arrive tomorrow and a 99% chance that it will arrive in the next two days.”

It is expected that such a message (displayed on a user's computer screen) will encourage the user to switch some or all of their business away from private couriers and towards using the present system. An additional advantage of the present system is that it tracks the package. Thus, the sender knows where the package is in the system and when it has been delivered. All of the above information (delivery time forecasts, cost savings and tracking info) will preferably be displayed to the sender on a web-interface operated by WALZ corporation. Also, the system will preferably inform the sender when the package has been delivered. (This could be done by displaying delivery confirmation information on a web pay, or by emailing the sender, or both).

Another advantageous feature of the present invention is that it preferably uses historical USPS delivery performance records to develop its forecasts (in step 20). Thus, the determination of when a letter, parcel or package will likely arrive at its destination is calculated by comparing other packages moving from the sender's location to the recipient's location. For example, if a letter is sent from Los Angeles to New York, the present computer system will calculate how long it took for other packages to travel from Los Angeles to New York. Should the package be sent from one neighborhood in San Diego to another neighborhood in San Diego, the system would calculate the typical delivery time to deliver between those same neighborhoods in San Diego. Preferably, the data used will be based upon the records and experiences of the sender' previously sent letters and packages. In this way, the present system enables each sender to look at their own delivery history to develop their own individual forecasts.

The data used to make these forecast may comprise of published USPS delivery data. In addition, the historical USPS delivery performance records comprise delivery data of packages previously sent by the particular sender. Thus, the system may generate forecasts for “Client A” by looking at the delivery times that were previously experienced by Client A”. For example, if “Client A” sends a package from Los Angeles to New York, the present system may base the delivery forecasts on previous packages sent by “Client A” from Los Angeles to New York.

Alternatively, the historical USPS mail delivery records may comprise delivery data of packages previously sent by a plurality of different senders. For example, if “Client A” is sending a package from Los Angeles to New York, the present system may base its delivery forecasts on previous packages that “Client A”, “Client B”, “Client C”, et. al. previously sent from Los Angeles to New York.

As can be seen, the historical USPS delivery performance records are continuously updated based upon actual delivery times. Thus, the present invention provides a continuously-evolving database that can be used to predict delivery times with extreme accuracy. The present system can optionally tailor its forecasts to one particular client user, or can make delivery forecasts based on the composite records of many senders.

As stated above, the packages are scanned and tracked by the USPS. Thus, each package has a unique code identifier thereon. In one preferred aspect, the package is scanned by USPS when it is initially deposited into the USPS mail stream. An advantage of this is that postage can be charged when the package is scanned by the USPS (when initially deposited by the sender in the USPS mail stream). In contrast, national couriers invoice in arrears (which is how they typically add-on surcharges and fees). Since the mail is tracked, the mail piece is also scanned by a mail carrier upon delivery. In another aspect, postage can simply be applied when the label is completed. The present invention thus encompasses embodiments in which the postage is created before or during USPS scanning.

Another advantage of the present system is that it can be used with a number of different existing USPS services. For example, it can be used with USPS Certified Mail, USPS Priority Mail, or USPS First Class Mail. (If the mail is sent Certified, the mail piece may have the letter “C”, or the word “certified”, or a green stripe optionally displayed thereon.) Althernatively, the letter “F” can be used for First Class™ mail, or “P” for Priority Mail™. Thus, the present invention also provides “universal packaging” since the same physical envelope can be used for different services. Thus, using the present system, the USPS does not need to print different Certified, Priority and First Class envelopes.

It is to be understood that steps 20 to 60 need not be performed in any particular sequential order. For example, steps 10 to 30 and steps 40 to 70 can be performed in either order (i.e.: cost savings may be determined prior to determining delivery time). In addition, steps 40 and 50 may be performed in reverse order.

In further optional aspects, step 80 comprises generating a shipping label for the package based upon the recorded sender and recipient address information. In further optional aspects, step 90 comprises printing postage on the label based upon the recorded sender and recipient address information. It is to be understood that steps 80 and 90 are both optional and can be performed in either order.

In further aspects of the present invention, a system for tracking a package throughout the USPS mail stream is provided, comprising: a package travelling in a USPS mail stream between a sender and a recipient; and a data record associated with the package, the data record comprising (a) a calculated expected delivery time if the package is sent by the present (WALZ and USPS) system based upon both: (i) sender and recipient address information for the package, and (ii) historical USPS delivery performance records, and (b) calculated cost savings of sending the package by the present system as compared to sending the package via private courier.

A web-interface operable by the sender that displays the calculated expected delivery time and the calculated cost savings is also included. Preferably, this web-interface displays a delivery time map to the sender. This system also optionally comprises a shipping label including postage printed by the sender on the package.

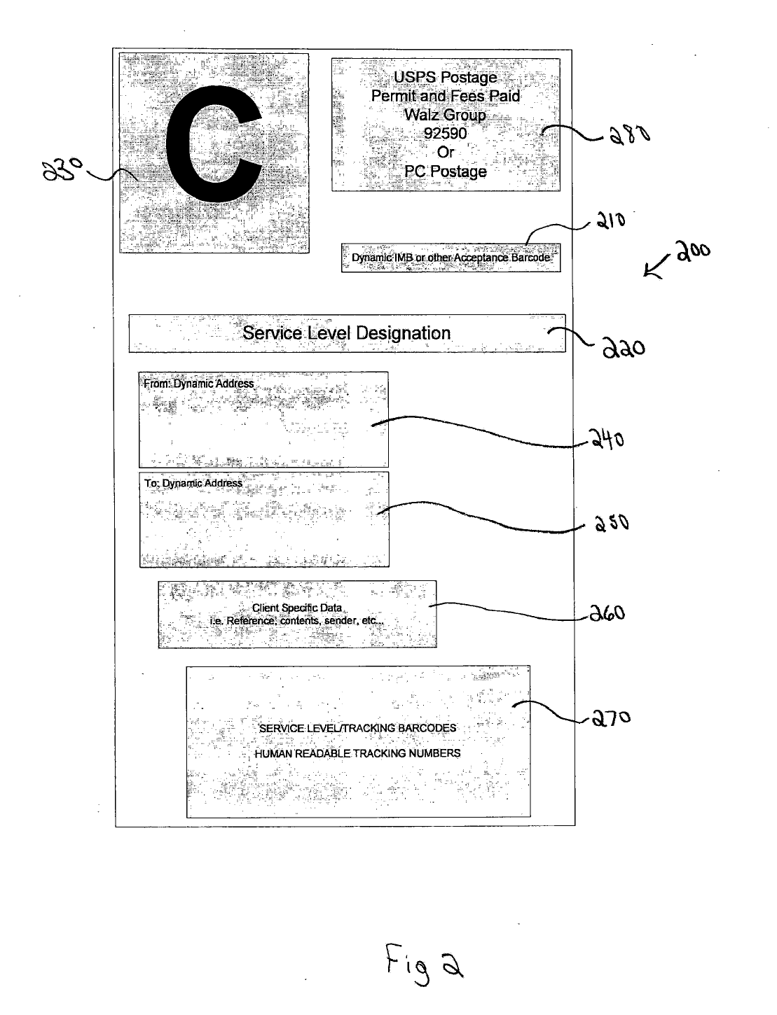

In further aspects, as shown in FIG. 2, the present invention comprises a trackable envelope 200 for shipping envelopes or packages. Envelope 200 can be sent through the USPS mail stream, and it has a unique machine readable identifier 210 thereon. In accordance with the present invention, when machine readable identifier 210 is read by a USPS scanner (and the present associated computer system), it: (i) identifies the package as being from a particular USPS class of tracked mail, and (ii) provides a data record associated with the package. Preferably, the data record comprises: (1) a calculated expected delivery time if the package is sent through the USPS mail stream based upon both: (a) sender and recipient information for the package, and (b) historical USPS mail delivery records, and (2) a calculated cost savings of sending the package by the present system as compared to sending the package by private courier.

Preferably, when machine readable identifier 210 is read by a USPS scanner (and/or when initially placed into the mail stream), the present system then determines the postage to be paid by the sender. When machine readable identifier 210 is scanned by a mail carrier upon delivery, the present system confirms delivery to the recipient.

An important advantage of the present system is that envelope 200 can be used as a Certified, Priority or First Class USPS mail envelope. This information can be printed in field 220 as the “service level designation”. In the case that envelope 200 is sent by USPS First Class mail, field 230 may have the letter “F”, or the phrase “First Class” therein. In the case that envelope 200 is sent by USPS Priority mail, field 230 may have the letter “P”, or the phrase “Priority Mail” therein. In the case that envelope 200 is sent by USPS Certified mail, field 230 may have the letter “C”, or the word “certified” therein.

It is to be understood that the present system comprises embodiments of envelope 200 with the addresses and various fields printed onto the envelope. The system also comprises embodiments where all the addresses and various fields are printed onto one or more labels, and the labels are fastened onto the envelope. (Thus, element 200 in FIG. 2 may be an envelope or a shipping label that is attached to an envelope, parcel or package).

It is also to be understood that the illustration in FIG. 2 is only an example of the positions of the various fields. The present invention also comprises envelopes (or mailing labels) in which the sizes and locations of the various fields can be different from that illustrated. In addition, the present invention encompasses envelopes and mailing labels having more or less fields than those illustrated.

Field 240 is the sender's information. Field 250 is the recipient's information. Field 260 is client specific data such as client reference numbers or contents listing. Field 270 is a special services barcode and enables tracking data inherent to special services. Field 280 is postage printed by the sender on the mail piece.

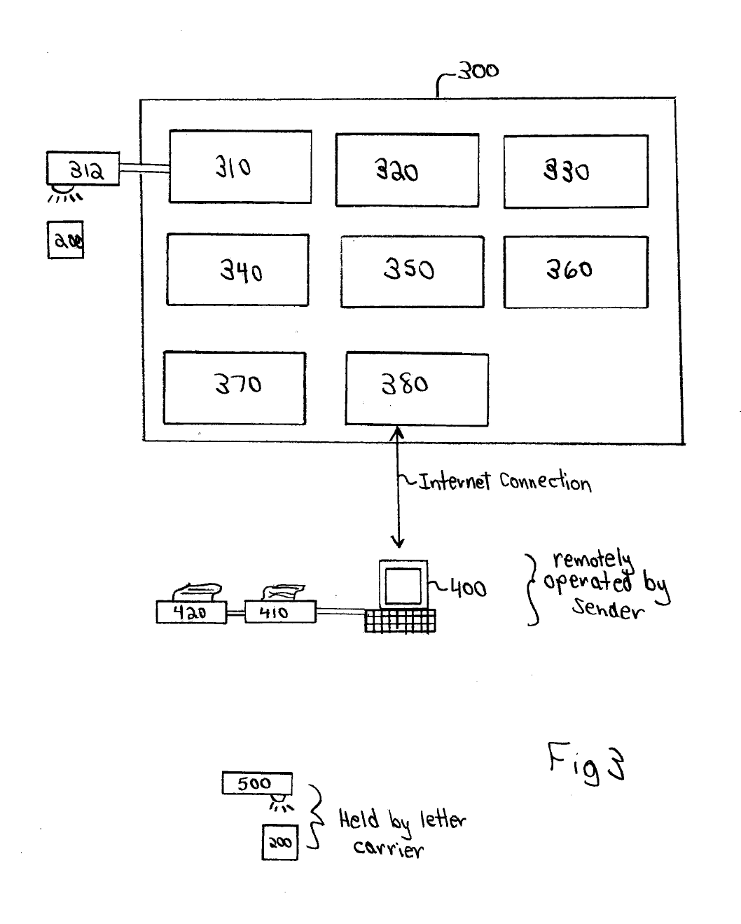

Lastly, as seen in FIG. 3, the present invention also comprises a computerized system 300 for tracking envelopes, packages or any other mail piece. System 300 preferably comprises: a sub-system 310 for recording sender and recipient information for the envelopes or packages; a sub-system 320 for calculating an expected delivery time for individual envelopes or packages if the individual pieces are sent by a first mail service (e.g.: WALZ/USPS) based upon both: (i) the sender and recipient address information for the package, and (ii) historical USPS mail delivery records; a sub-system 330 for providing senders with the expected delivery time for the individual packages if the packages are sent by the first mail service; a sub-system 340 for determining a cost of sending the individual packages by the first mail service; a sub-system 350 for determining a cost of sending the individual pieces by a second mail service (e.g.: a private courier); a sub-system 360 for calculating a cost savings by sending the individual packages by the first mail service as compared to sending the piece by the second mail service; and a sub-system 370 for providing the sender with the calculated cost savings of sending the individual pieces by the first mail service as compared to sending the individual pieces by the second mail service.

Sub-system 310 may record sender and recipient address information through a scanner 312. The data obtained by scanner 312 is input into system 300. Alternatively, the sender may simply input the recipient's information through a web-interface (hosted by WALZ corporation). The sender's address can be maintained in this system and edited if needed. Thus, the USPS only needs to track the package ID or tracking number(s) that have been assigned to that specific package. Sub-system 310/scanner 312 can also be used for scanning the packages and charging postage when the mail pieces are initially deposited by the sender in the USPS mail stream.

The sender operates a web-interface 400 for displaying the expected delivery time and calculated cost savings (as calculated by sub-systems 330 and 370 respectively). A sub-system 380 notifies the sender of the actual delivery of the packages. Optionally included is a sub-system 410 operated by each of the senders for printing shipping labels on the packages, and/or a sub-system 420 for the senders to print postage on the packages (or on labels, that are attached to the mail pieces or plain paper which is slipped into the plasticine sleeve).

Finally, the letter carrier has a sub-system/scanner 500 for scanning the packages 200 upon delivery, thereby confirming delivery to the sender.

As can be seen, the present invention provides a system in which a mail piece can optionally be weighed, paid, accepted and tracked in real time. Alternatively, however, postage can be applied at different stages in the process. The present invention thus covers embodiments in which postage is applied at different times. Software associated with the present system enables the creation, tracking and archiving of all the data points, and makes this information useful to customers. As such, the present invention solves the problem of metering and documentation while reducing costs and providing hyper visibility of the mail piece(s) in the mail stream.

What is claimed is:

1. A method of providing a sender of a package with: (i) a calculated delivery time if the package is sent by a first mail service, and (ii) a calculated delivery cost savings by sending the package by the first mail service as compared to sending the package by a second mail service, comprising:
recording sender and recipient address information for the package;
calculating an expected delivery time if the package is sent by the first mail service based upon both: (i) the sender and recipient address information for the package, and (ii) historical delivery performance records of the first mail service;
providing the sender with the expected delivery time if the package is sent by the first mail service;
determining a cost of sending the package by the first mail service;
determining a cost of sending the package by the second mail service;
calculating a cost savings by sending the package by the first mail service as compared to sending the package by the second mail service; and
providing the sender with the calculated cost savings of sending the package by the first mail service as compared to sending the package by the second mail service.

2. The method of claim 1, wherein the first mail service is the USPS and the second mail service is a private courier.

3. The method of claim 2, wherein the first mail service is operated by WALZ corporation in conjunction with the USPS.

4. The method of claim 1, wherein the expected delivery time is displayed on a web-interface.

5. The method of claim 1, wherein the calculated cost savings of sending the package by the first mail service as compared to sending the package by the second mail service is displayed on a web-interface operated by the sender.

6. The method of claim 1, further comprising:
informing the sender when the package has been delivered.

7. The method of claim 6, wherein informing the sender when the package has been delivered comprises displaying delivery information on a web-interface operated by the sender.

8. The method of claim 6, wherein informing the sender when the package has been delivered comprises emailing delivery information to the sender.

9. The method of claim 1, wherein the historical mail delivery records of the second mail service comprise published USPS delivery data.

10. The method of claim 1, wherein the historical mail delivery records of the second mail service comprise delivery data of packages or mail pieces previously sent by the sender.

11. The method of claim 1, wherein the historical mail delivery records of the second mail service comprise delivery data of packages or mail pieces previously sent by a plurality of different senders.

12. The method of claim 1, wherein the historical mail delivery records of the second mail service are continuously updated based upon actual mail deliveries.

13. The method of claim 12, wherein the actual mail deliveries are deliveries made by the same sender.

14. The method of claim 12, wherein the actual mail deliveries are deliveries made by a plurality of different senders.

15. The method of claim 1, wherein the package has a unique code identifier thereon.

16. The method of claim 15, wherein the package is scanned by USPS when initially deposited by the sender in the mail stream of the first mail service.

17. The method of claim 16, wherein postage is charged when the package is scanned by the first mail service when initially deposited by the sender in the mail stream of the first mail service.

18. The method of claim 1, wherein the package is sent by USPS Certified mail.

19. The method of claim 1, wherein the package is sent by USPS Priority mail.

20. The method of claim 1, wherein the package is sent by USPS First Class mail.

21. The method of claim 1, wherein the package is scanned by a mail carrier upon delivery.

22. The method of claim 1, wherein the label has any one of the indicia “C”, “certified”, “F”, “First Class”, “P”, or “Priority” displayed thereon.

23. The method of claim 1, further comprising:
generating a mailing label for the package based upon the recorded sender and recipient information.

24. The method of claim 1, further comprising:
printing postage on the label based upon the recorded sender and recipient information.

25. A system for tracking a package in a first mail stream, comprising:
a package travelling in a first mail stream between a sender and a recipient; and
a data record associated with the package, the data record comprising:
a calculated expected delivery time if the package is sent by a first mail service based upon both: (i) sender and recipient information for the package, and (ii) historical mail delivery records of the first mail service, and
a calculated cost savings of sending the package by the first mail service as compared to sending the package by a second mail service.

26. The system of claim 25, wherein the first mail service is the USPS and the second mail service is a private courier.

27. The system of claim 26, wherein the first mail service is operated by a corporation in conjunction with the USPS.

28. The system of claim 25, further comprising:
a web-interface operable by the sender, the web-interface displaying the calculated expected delivery time and the calculated cost savings.

29. The system of claim 25, wherein the historical mail delivery records of the first mail service comprise published USPS delivery data.

30. The system of claim 25, wherein the historical mail delivery records of the first mail service comprise delivery data of packages previously sent by the sender.

31. The system of claim 25, wherein the historical mail delivery records of the first mail service comprise delivery data of packages previously sent by a plurality of different senders.

32. The system of claim 25, wherein the historical mail delivery records of the first mail service are continuously updated based upon actual mail deliveries.

33. The system of claim 25, wherein the package has a unique code identifier thereon.

34. The system of claim 25, wherein the package has the letter “C”, or the word “certified”, or a green stripe displayed thereon.

35. The system of claim 25, further comprising:
a mailing label printed by the sender on the package.

36. The system of claim 25, further comprising:
postage printed by the sender on the label

37. The system of claim 28, wherein the web-interface displays a delivery time map to the sender.

38. The system of claim 28, wherein the web-interface displays the calculated expected delivery time and the calculated cost savings prior to actual delivery of the package.

39. A trackable envelope or package for shipping documents, comprising:
an envelope or package; and
a unique machine readable identifier on the envelope or package or on a label affixed to the envelope or package, wherein the machine readable identifier, when read by a scanner:
(i) identifies the package as being from a particular class of tracked mail provided by a first mail service,
(ii) provides a data record associated with the package, the data record comprising:
(1) a calculated expected delivery time if the package is sent by the first mail service based upon both:
(a) sender and recipient information for the package, and
(b) historical mail delivery records for the first mail service, and
(2) a calculated cost savings of sending the package by the first mail service as compared to sending the package by a second mail service.

40. The trackable envelope or package of claim 39, wherein the first mail service is the USPS and the second mail service is a private courier.

41. The trackable envelope or package of claim 40, wherein the first mail service is operated by WALZ corporation in conjunction with the USPS.

42. The trackable envelope or package of claim 40, wherein the particular USPS class of tracked mail is one of USPS Certified, USPS Priority or USPS First Class mail.

43. The trackable envelope or package of claim 39, wherein the machine readable identifier, when read by a scanner, determines the postage to be paid by the sender.

44. The trackable envelope or package of claim 39, wherein the machine readable identifier, when scanned by a mail carrier upon delivery, confirms delivery to the recipient.

45. The trackable envelope or package of claim 39, wherein the envelope has any one of the indicia “C”, “certified”, “F”, “First Class”, “P”, or “Priority” displayed thereon

46. The trackable envelope or package of claim 39, further comprising:
a mailing label printed by the sender on the package.

47. The trackable envelope or package of claim 39, further comprising:
postage printed by the sender on the label and/or package.

48. A computerized system for tracking mail delivered by a first mail service, comprising:
a sub-system for recording sender and recipient information for mail delivered by a first mail service;
a sub-system for calculating an expected delivery time for individual packages if the individual packages are sent through the first mail stream based upon both: (i) the sender and recipient information for the package, and (ii) historical mail delivery records for the first mail service;
a sub-system for providing senders with the expected delivery time for the individual packages if the packages are sent through the mail stream of the first mail service;
a sub-system for determining a cost of sending the individual packages by the first mail service;
a sub-system for determining a cost of sending the individual packages by a second mail service;
a sub-system for calculating a cost savings by sending the individual packages by the first mail service as compared to sending the package by the second mail service; and
a sub-system for providing the sender with the calculated cost savings of sending the individual packages by the first mail service as compared to sending the individual packages by the second mail service.

49. The computerized system of claim 48, further comprising:
a web-interface for displaying the expected delivery time and calculated cost savings to the senders.

50. The computerized system of claim 48, further comprising:
a sub-system for notifying the sender of the actual delivery of the packages.

51. The computerized system of claim 48, further comprising:
a sub-system operated by each of the senders for printing mailing labels on the packages, thermal labels or plain paper inserted into a plasticine sleeve.

52. The computerized system of claim 48, further comprising:
a sub-system operated by each of the senders for printing postage on the packages, labels or plain paper inserted into a plasticine sleeve.

53. The computerized system of claim 48, wherein the historical mail delivery records of the first mail service comprise published USPS delivery data.

54. The computerized system of claim 48, wherein the historical mail delivery records of the first mail service are continuously updated based upon actual mail deliveries.

55. The computerized system of claim 48, further comprising:
a sub-system for scanning the packages and charging postage when the packages are initially deposited by the sender in the mail stream of the first mail service.

56. The computerized system of claim 48, further comprising:
a sub-system for scanning the packages by a mail carrier upon delivery, thereby confirming delivery to the sender.

57. The computerized system of claim 48, wherein sending the packages by the first mail service comprises sending the packages by USPS Certified, Priority or First Class mail.
